(19) United States
(12) Patent Application Publication
(10) Pub. No.: US 2007/0223258 A1
(43) Pub. Date: Sep. 27, 2007

(54) Multilevel converters for intelligent high-voltage transformers

(76) Inventors: Jih-Sheng Lai, Blacksburg, VA (US); Arindam India Maitra, Knoxville, TN (US); Frank Goodman, Palo Alto, CA (US)

Correspondence Address: ELECTRIC POWER RESEARCH INSTIUTE, C/O KILPATRICK STOCKTON LLP, 1001 WEST FOURTH STREET, WINSTON - SALELM, NC, 27101, US

(21) Appl. No.: 11/705,081

(22) Filed: Feb. 8, 2007

Related U.S. Application Data
(63) Continuation-in-part of application No. 11/246,800, filed on Oct. 7, 2005.
(63) Continuation-in-part of application No. 11/438,785, filed on May 22, 2006.
Application No. 11/246,800 is a division of application No. 10/723,620, filed on Nov. 25, 2003, now Pat. No. 6,954,366.
Application No. 11/438,785 is a continuation of application No. 10/723,621, filed on Nov. 25, 2003, now Pat. No. 7,050,311.

(51) Int. Cl. H02M 5/45

(52) U.S. Cl. 363/37

(57) ABSTRACT

A power conversion device includes a switched AC-to-DC converter circuit coupled to a device input and a switched DC-to-AC converter circuit coupled to the switched AC-to-DC converter circuit and a device output. The switched AC-to-DC converter circuit and the switched DC-to-AC converter circuit are configurable for multi-level step-up and/or step-down conversion.

### CROSS-REFERENCE TO RELATED APPLICATIONS

This application is a continuation-in-part of pending U.S. patent application Ser. No. 11/246,800, filed Oct. 7, 2005; which is a divisional of U.S. patent application Ser. No. 10/723,620, filed Nov. 25, 2003, now U.S. Pat. No. 6,954,366; and is a continuation-in-part of pending U.S. patent application Ser. No. 11/438,785, filed May 22, 2006; which is a continuation of U.S. patent application Ser. No. 10/723,621, filed on Nov. 25, 2003, now U.S. Pat. No. 7,050,311. Each of the foregoing applications and patents are incorporated by reference herein in their entireties.

### TECHNICAL FIELD

The present invention relates generally to power conversion technology and in particular to an all-electronic multilevel converter for high-voltage transformer applications.

### BACKGROUND

Transformers have numerous applications including voltage or current conversion, impedance matching and electrical isolation. As a consequence, transformers are widely used throughout the world, forming the backbone of electric power conversion systems, and make up a large portion of power delivery systems. The positive attributes of conventional transformers have been well documented for years and include low cost, high reliability, and high efficiency. Were it not for these highly reliable devices, activities such as recharging batteries in a portable device or consumers receiving power from a distant electric generator would be prohibitively expensive, resulting in electricity being a much less practical form of energy.

Autotransformers are a subset of transformers in which primary and secondary coils have some or all of their windings in common. FIG. 1 illustrates a conventional autotransformer 100 that may be used to convert an input V₁ 110, having a first ac voltage and current level and a first frequency, to an output V₂ 112, having a second ac voltage and current level and a second frequency equal to the first frequency. Conventional autotransformers, such as the conventional autotransformer 100, typically utilize a copper and iron-based core to perform such a power transformation. In the conventional auto-transformer 100, the second ac voltage and current level may be adjusted by selecting a number of windings or taps in the core that are coupled to the output V₂ 112.

Conventional auto-transformers, however, have some drawbacks. The first voltage of the input V₁ 110 is typically higher than the second voltage of the output V₂ 112. Power typically, flows only from the primary side to the secondary side. In addition, the voltage of the output V₂ 112 drops under load; there is a sensitivity to harmonics generated in a load, environmental impacts occur if mineral oil in the core leaks; there is little or no flexibility in adjusting the power conversion (including voltages/currents, and/or the first or second frequencies); and there is no energy-storage capacity. One consequence of not having energy storage capacity is that the output V₂ 112 can be easily interrupted because of a disturbance at the input V₁ 110.

There is a need, therefore, for improved auto-transformers.

### SUMMARY

An all-electronic multilevel converter for intelligent high-voltage transformer applications includes power electronics on a primary side and on a secondary side to enhance the functionality of power conversion. The all-electronic multilevel intelligent converter may be an auto-transformer.

In some embodiments, a power conversion device includes a switched AC-to-DC converter circuit coupled to a device input and a switched DC-to-AC converter circuit coupled to the switched AC-to-DC converter circuit and a device output. The switched AC-to-DC converter circuit and the switched DC-to-AC converter circuit are configurable for multi-level step-up and/or step-down conversion.

The switched AC-to-DC converter circuit may be configured to output a DC voltage that is larger than a peak voltage of signals at the device input.

A first filter may be coupled to the device input and/or a second filter may be coupled to the device output. The first filter and/or the second filter may be configured to provide substantially sinusoidal signals.

An energy storage device (e.g., ultra-capacitor) may be coupled between the switched AC-to-DC converter circuit and the switched DC-to-AC converter circuit to mitigate voltage disturbances. The energy storage device may include a number of storage devices equal to a number of conversion levels for signals at the device input and/or the device output.

The first switched converter circuit and the second switched converter circuit may be configured to utilize duty-cycle modulation to implement the multi-level step-up and/or step-down conversion. The switched DC-to-AC converter circuit may be configured such that signals between the switched DC-to-AC converter circuit and the second filter are pulse-width modulated.

The switched AC-to-DC converter circuit may include a first plurality of configurable semiconductor switches, and the switched DC-to-AC converter circuit may include a second plurality of configurable semiconductor switches. The first plurality of configurable semiconductor switches and/or the second plurality of configurable semiconductor switches may include silicon insulated-gate bipolar transistors (IGBT).

In some embodiments, the switched AC-to-DC converter circuit is configured to adjust a first number of conversion levels of signals at the device input, and/or the switched DC-to-AC converter circuit is configured to adjust a second number of conversion levels of signals at the device output.

In some embodiments, the device is configurable for bidirectional power flow. In some embodiments, a frequency of signals at the device output is configurable.

In some embodiments, the switched AC-to-DC converter circuit is configured to receive signals at the device input having 3-phases separated by approximately 120° and/or the switched DC-to-AC converter circuit is configured to output signals at the device output having 3-phases separated by approximately 120°.

A significant advantage of the present invention is the combining of the functionalities of one or more custom power devices into a single, tightly integrated, electrical device, rather than the costly conventional solution of utilizing separate custom power devices.

### BRIEF DESCRIPTION OF THE DRAWINGS

FIG. 1 is a circuit diagram illustrating a conventional auto-transformer;

FIG. 2 is a circuit diagram illustrating an embodiment of an intelligent high-voltage transformer;

FIG. 3A is a circuit diagram illustrating an embodiment of a portion of an intelligent high-voltage transformer;

FIG. 3B is a circuit diagram illustrating an embodiment of a portion of an intelligent high-voltage transformer;

FIG. 4 is a circuit diagram illustrating an embodiment of an intelligent high-voltage transformer;

FIG. 5 is a circuit diagram illustrating an embodiment of a control system;

FIG. 6 is a diagram illustrating input and output signals in an embodiment of an intelligent high-voltage transformer;

FIG. 7 is a diagram illustrating pulse width modulated signals in an embodiment of an intelligent high-voltage transformer;

FIG. 8 is a flow diagram illustrating an embodiment of a process of operation of an intelligent high-voltage transformer; and

FIG. 9 is a block diagram illustrating an embodiment of a system.

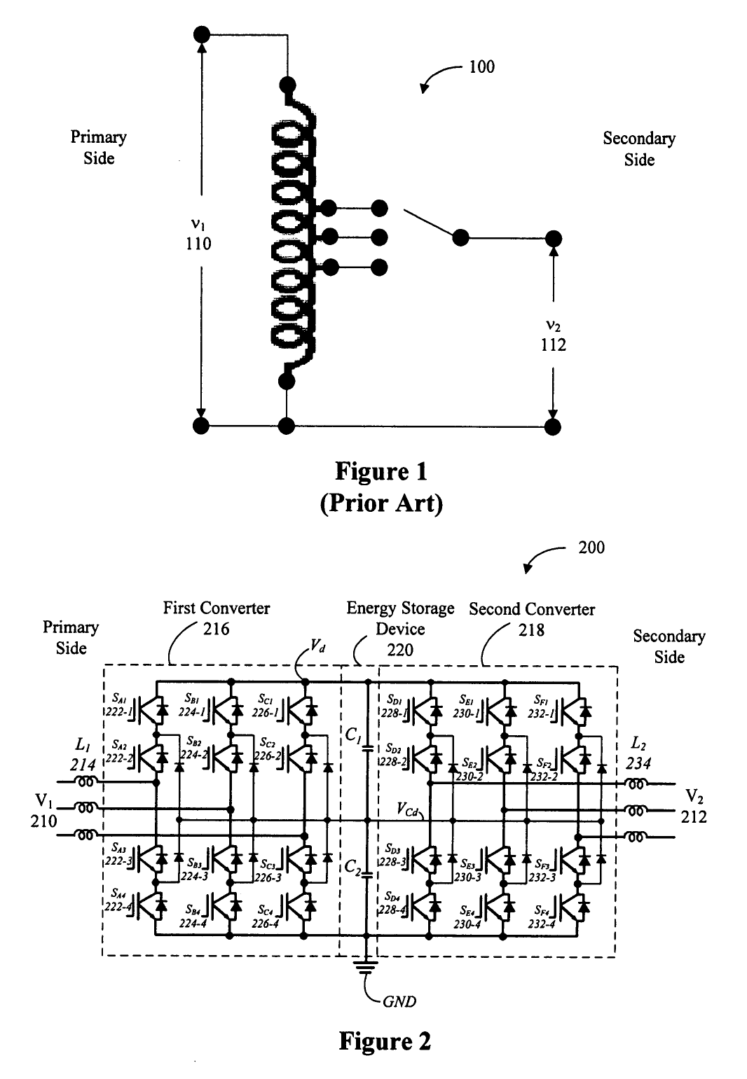

Like reference numerals refer to corresponding parts throughout the drawings.

### DETAILED DESCRIPTION

Reference will now be made in detail to embodiments of an all-electronic multilevel converter for intelligent high-voltage transformer (henceforth referred to as intelligent high-voltage transformer), examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and circuits have not been described in detail so as not to unnecessarily obscure aspects of the embodiments.

The intelligent high-voltage transformer utilizes modern power electronics to replace the core in a conventional auto-transformer and thereby enhance the power conversion functionality. In some embodiments, the intelligent high-voltage transformer includes a plurality of power semiconductor switches in at least first and second switched converter circuits corresponding to the primary side and the secondary side, respectively, of a conventional auto-transformer.

The intelligent high-voltage transformer may include an energy storage device, such as one or more capacitors, between the first and the second switched converter circuits. The energy storage device may serve as the energy buffer in between the source and load to avoid direct impact from either the load to the source or the source to the load. The energy storage device may allow the intelligent high-voltage transformer to at least partially compensate for outages, where input signals to the intelligent high-voltage transformer are temporarily reduced (such as voltage sag) or disrupted.

The power electronic switches in the first and the second switched converter circuits may allow the intelligent high-voltage transformer to be configured in a variety of ways. The intelligent high-voltage transformer may be configured for one of a range of step-up or step-down voltage and/or current conversions. A voltage and/or current of the output signals may be regulated. Harmonics generated by nonlinearities in a load, as seen from the input, may be reduced or eliminated. A frequency of the output signals may be adjusted and/or selected (e.g., DC, 50 Hz, 60 Hz, 400 Hz, etc.). The input and/or the output signals may be approximately uni-phase or poly-phase, such as tri-phase signals where signals are separated by approximately 120°. In addition, the intelligent high-voltage transformer may be configured for bidirectional power flow. For example, power may flow from the primary side to the secondary side or from the secondary side to the primary side.

These features allow the intelligent high-voltage transformer to integrate the functionalities of one or more custom power devices. Such a “hybrid” intelligent high-voltage transformer thereby overcomes at least some of the deficiencies of existing auto-transformers, such as the conventional auto-transformer 100, in a cost effective manner. In addition, the intelligent high-voltage transformer may have a reduced size and improved power quality performance relative to conventional auto-transformers.

FIG. 2 is a circuit diagram illustrating an embodiment of an intelligent high-voltage transformer 200. The intelligent high-voltage transformer 200 is a 3-level converter three-phase to three-phase step-down auto-transformer. The intelligent high-voltage transformer 200 includes a first converter 216, a second converter 218, and an energy storage device 220. The intelligent high-voltage transformer 200 has a supply voltage V_{d}, a common voltage V_{Cd}, and a ground GND.

The first converter 216 on the primary side functions as an AC-to-DC boost converter, in which an output dc bus voltage may be higher than a peak voltage of an input V₁ 210 that has three approximately sinusoidal input signals separated in phase by approximately 120°. The first converter 216 includes three groups (one for each phase leg) of four switches S_{A} 222, S_{B} 224, and S_{C} 226, as well as anti-parallel diode protection. Three inductors L₁ 214 coupled to the first converter 214 serve as boost inductors.

The second converter 218 functions as a DC-to-AC converter. The second converter 218 inverts the output dc bus voltage from the first converter 216 to an ac output V₂ 212. The second converter 218 includes three groups (one for each phase leg) of four switches S_{D} 228, S_{E} 230, and S_{F} 232, as well as anti-parallel diode protection. Duty-cycle modulation (using control signals described further below) of the switches S_{D} 228, S_{E} 230, and S_{F} 232 gives the ac output V₂ 212 a pulse-width-modulated (PWM) square shape (as described further below with reference to FIG. 7).

The inductors L₁ 214 and L₂ 234 in conjunction with an input and an output capacitance, respectively, form low-pass filters to provide filtering of high frequencies signals and/or smoothing of noise. In this way, the input V₁ 210 is approximately sinusoidal having the first frequency and/or the output V₂ 212 is approximately sinusoidal having the second frequency. An approximately sinusoidal signal has substantially reduced ripple. In some embodiments, the first frequency may be different that the second frequency (e.g., DC, 50 Hz, 60 Hz, or 400 Hz) depending on the duty cycle modulation of the switches S_{A} 222, S_{B} 224, S_{C} 226, S_{D} 228, S_{E} 230, and/or S_{F} 232. Note that other combinations of passive and/or active devices can be coupled to the primary side and/or the secondary side of the intelligent high-voltage transformer 200 to provide filtering using well-known filter design techniques.

The energy storage device 220 includes two capacitors, connected in series, in parallel with an output from the first converter 216 and an input to the second converter 218. More generally, the energy storage device 220 may include at least a number of storage devices equal to a number of conversion levels for signals at the input V₁ 210 to and/or the output V₂ 212 from the intelligent high-voltage transformer 200. In some embodiments, the energy storage device 220 may include a battery. The energy storage device 220 may be any DC voltage source capable of maintaining voltage for a sufficient period of time to compensate for a disturbance or interruption, such as an outage, and may include capacitor banks, ultra-capacitors, flywheels, batteries, or any other suitable storage media (or any combination thereof). If the intelligent high-voltage transformer 200 is used in an application or system that requires outage compensation or short-term interruption protection, the energy storage device 220 may allow the intelligent high-voltage transformer 200 to ride-through these disturbances. When a voltage of the input V₁ 210 drops for a short period of time, the energy storage device 220 may compensate for the deficit and maintain constant voltage amplitude for the output V₂ 212. The total period of compensation as a function of the amount of energy storage may be adapted as desired. In some embodiments, an additional device, such as a battery, in the energy storage device 220 may be switched into the intelligent high-voltage transformer 200 upon detection of a voltage sag and/or to provide outage compensation.

The intelligent high-voltage transformer 200 converts the input V₁ 210 to the output V₂ 212. Duty cycle modulation of signals (for example, using pulse width modulation) controlling the switches S_{A} 222, S_{B} 224, S_{C} 226, S_{D} 228, S_{E} 230, and/or S_{F} 232 allows the step-down voltage (between the input V₁ 210 and the output V₂ 212) to be adjusted and/or configured. The intelligent high-voltage transformer 200 may be configured such that power flows from the primary side to the secondary or load side, or vice versa. In the latter case, the first converter 216 functions as an inverter, and the second DC-to-AC converter 218 functions as a converter.

The switches S_{A} 222, S_{B} 224, S_{C} 226, S_{D} 228, S_{E} 230, and/or S_{F} 232 may be semiconductor switches that may be rapidly switched (approximately at 30,000 to 40,000 Hz). The switches S_{A} 222, S_{B} 224, S_{C} 226, S_{D} 228, S_{E} 230, and/or S_{F} 232 may include Gate-Turn-Off (GTO) Thyristors, Integrated Gate Bipolar Transistors (IGBTs), MOS Turn-off Thyristors (MTOs), Integrated-Gate Commutated Thyristors (IGCTs), Silicon Controlled Rectifiers (SCRs), or any other semiconductor devices that have a turn-off capability.

In addition to performing power conversion and/or adjustment or selection of the second frequency, the intelligent high-voltage transformer 200 will also isolate the voltage of the input V₁ 210 and the current from the output V₂ 212. Thus, transients, such as those generated by a power factor correction capacitor switching event, will not propagate to the secondary or load side of the intelligent high-voltage transformer 200. In addition, harmonics, such as those generated in a non-linear load or by reactive power in the load, will not propagate to the primary side. This may be accomplished by actively switching the switches S_{A} 222, S_{B} 224, and S_{C} 226 in the first converter 216 such that an input current becomes sinusoidal and in phase with the voltage of the input V₁ 210.

In some embodiments, the intelligent high-voltage transformer 200 may include fewer components or additional components. For example, a number of switches and/or their switching frequency may be different from that illustrated in the intelligent high-voltage transformer 200. The input V₁ 210 and/or the output V₂ 212 may be single phased. Alternatively, full-bridge converters (as opposed to half-bridge converters) may be used for the first converter 216 and/or the second converter 218. Functions of two or more components may be combined. An order or relative position of two or more components may be interchanged.

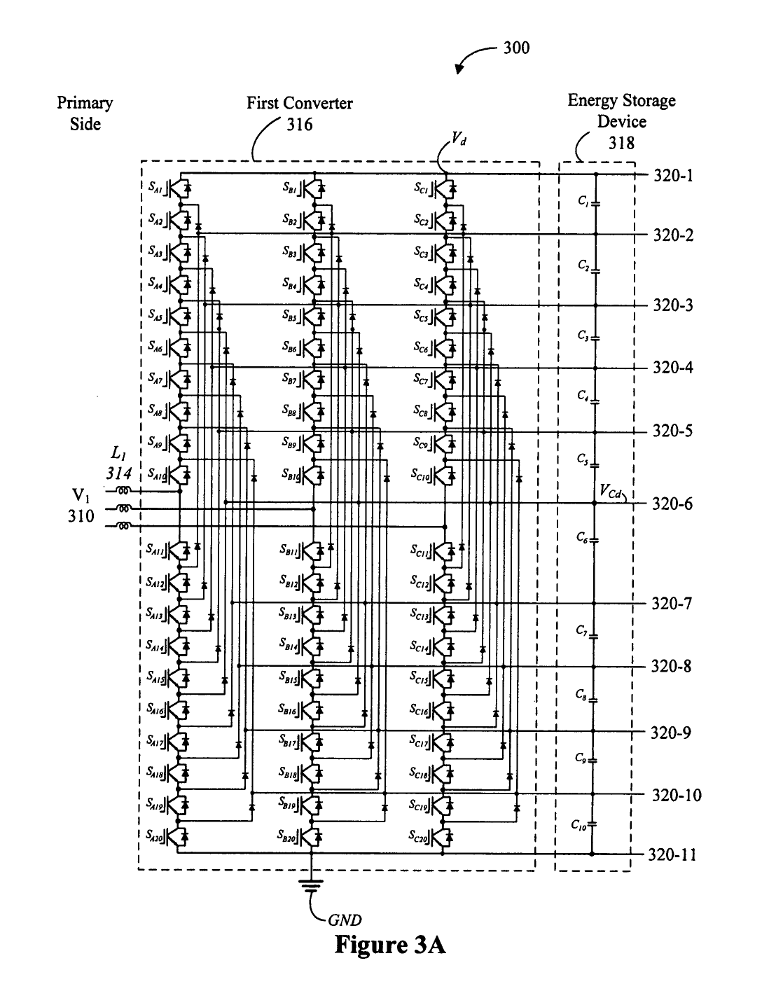

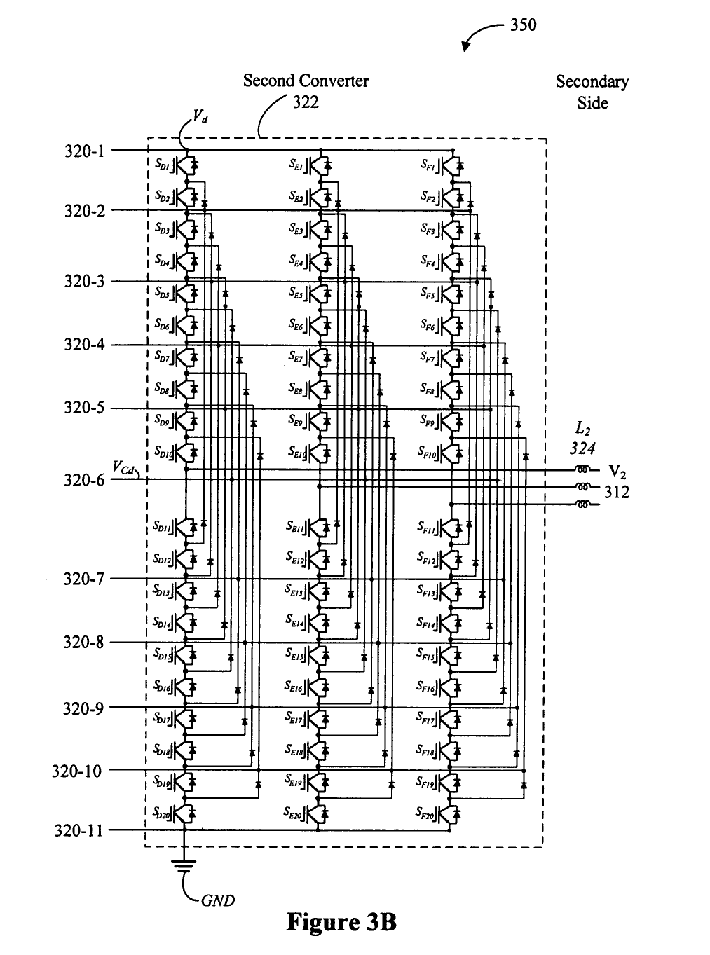

For higher voltages, the number of converter levels and switches may be further increased, as illustrated in FIGS. 3A and 3B, which each show a circuit diagram of a portion of an embodiment 300 and 350, respectively, of an intelligent high-voltage transformer. In embodiments 300 and 350, the intelligent high-voltage transformer converts an input V₁ 310 to an output V₂ 312 using an 11-level first converter 316, an 11-level second converter 322, and an energy storage device 318. Outputs 320 from the energy storage device 318 are coupled to the second converter 322. The intelligent high-voltage transformer in the embodiments 300 and 350 has a supply voltage V_{d}, a common voltage V_{Cd}, and a ground GND. The first converter 316 on the primary side includes three groups (one for each phase leg) of 20 switches S_{A}, S_{B}, and S_{C}, as well as anti-parallel diode protection. The second converter 322 on the secondary side includes three groups (one for each phase leg) of 20 switches S_{D}, S_{E}, and S_{F}, as well as anti-parallel diode protection. The energy storage device 318 includes a plurality of capacitors C, connected in series, that are in parallel with an output from the first converter 316 and an input to the second converter 322. In some embodiments, the energy storage device 318 may include an additional device, such as a battery, as described above for the intelligent high-voltage transformer 200 (FIG. 2). The intelligent high-voltage transformer in embodiments 300 and 250 may also include inductors L₁ 314 and L₂ 324 or other active or passive components to provide filtering of high frequencies signals and/or smoothing of noise.

While the function of the switches S_{A}, S_{B}, S_{C}, S_{D}, S_{E}, and S_{F} and that of the intelligent high-voltage transformer in embodiments 300 and 350 as a whole is similar to that of the switches S_{A} 222, S_{B} 224, S_{C} 226, S_{D} 228, S_{E} 230, and S_{F} 232 (FIG. 2) and the universal auto-transformer 200 (FIG. 2), increasing the number of levels (and switches) has advantages for higher voltage applications. Each of the switches S_{A}, S_{B}, S_{C}, S_{D}, S_{E}, and S_{F} blocks a reduced fraction of the DC bus voltage. As a consequence, the intelligent high-voltage transformer in embodiments 300 and 350 may be used with higher high-voltages for the input V₁ 310 and/or the output V₂ 312 without using higher voltage devices for the switches S_{A}, S_{B}, S_{C}, S_{D}, S_{E}, and S_{F}.

In an exemplary embodiment, the voltage amplitude of the input V₁ 310 is 345 kV and the voltage amplitude of the output V₂ 312 is 220 kV. If silicon power semiconductor devices (having a voltage limit of 6.5 kV) are used for the switches S_{A}, S_{B}, S_{C}, S_{D}, S_{E}, and S_{F}, the first converter 316 and the second converter 322 would have more than 100 conversion levels. The large number of switches used to implement such a large number of conversion levels may pose control issues. If wide-band-gap power semiconductor devices (having a voltage limit of 65 kV) are used for the switches S_{A}, S_{B}, S_{C}, S_{D}, S_{E}, and S_{F}, 11-level converters may be utilized, as illustrated in embodiments 300 and 350.

In some embodiments, the intelligent high-voltage transformer in embodiments 300 and 350 may include fewer components or additional components. For example, a number of conversion levels, a number of switches, and/or their switching frequency may be different from that illustrated in embodiments 300 and 350. The input V₁ 310 and/or the output V₂ 312 may be single phased. Alternatively, full-bridge converters (as opposed to half-bridge converters) may be used for the first converter 316 and/or the second converter 322. Functions of two or more components may be combined. An order or relative position of two or more components may be interchanged.

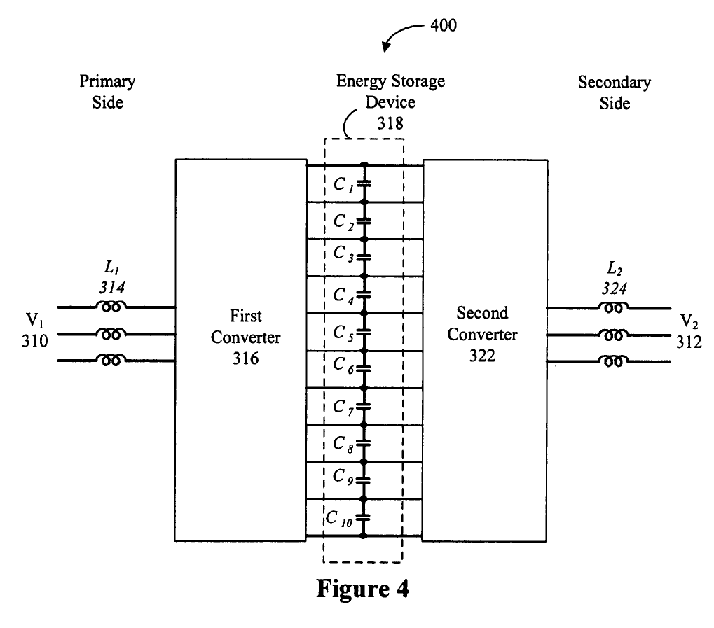

FIG. 4 is a circuit diagram illustrating an embodiment of an intelligent high-voltage transformer 400, such as that illustrated in embodiments 300 and 350 (FIGS. 3A and 3B). An input V₁ 310 is converted to an output V₂ 312 using the 11-level first converter 316, the 11-level second converter 322, and the energy storage device 318. The intelligent high-voltage transformer 400 may also include inductors L₁ 314 and L₂ 324, or other active or passive components to provide filtering of high frequencies signals and/or smoothing of noise.

As illustrated in the preceding discussion, the number of configurable switches on the primary and/or the secondary side of the intelligent high-voltage transformer may be selected and/or configured. In some embodiments, a first number of switches in the converter circuit on the primary side is based on a voltage of signals at the device input and a voltage limit of the switches in the converter circuit on the primary side. In some embodiments, a second number of switches in the converter circuit on the secondary side is based on a voltage of signals at the device output and a voltage limit of the switches in the converter circuit on the secondary side. For example, the first number of switches may be increased if the voltage of signals at the device input is increased and/or the voltage limit of the switches in the converter circuit on the primary side is decreased. The first and/or the second number of switches may also be based on the number of phases in signals in the input and/or the output of an intelligent high-voltage transformer.

As illustrated in the preceding embodiments, the first number of switches in the converter on the primary side and/or the second number of switches in the converter on the secondary side may vary based on the design and/or application considerations. In some embodiments, the first number of switches equals 2(N₁−1), 3(N₁−1), 4(N₁−1), or 6(N₁−1), where N₁ is a number of conversion levels of the signals at the device input. In some embodiments, the second number of switches equals 2(N_{O}−1), 3(N_{O}−1), 4(N_{O}−1), and 6(N_{O}−1), where N_{O} is a number of conversion levels of the signals at the device output.

Referring to FIG. 2, the intelligent high-voltage transformer 200 and the switches S_{A} 222 and S_{D} 228 are used as an illustrative example of the operation of other embodiments of the intelligent high-voltage transformer for each phase leg. In the intelligent high-voltage transformer, the basic operation is to switch first set of switches S_{A1} 222-1 and S_{A2} 222-2, and second set of switches S_{D3} 228-3 and S_{D4} 228-4 in an alternating fashion such that an output of the first converter 216 is an alternating chopped DC voltage. The switches S_{D} 228 are similarly grouped and switched. The filter associated with L₂ 234 smoothes the resulting chopped DC voltage into a clean, sinusoidal waveform corresponding to one of the phases in the output V₂ 212.

The switches S_{A} 222, S_{B} 224, S_{C} 226, S_{D} 228, S_{E} 230, and S_{F} 232 may be controlled by an external control means using either analog or digital control signals in a manner commonly known to one of ordinary skill in the art. For example, the states of switches S_{A} 222, S_{B} 224, Sc 226, S_{D} 228, S_{E} 230, and S_{F} 232 may be controlled using pulse-width modulation (PWM) techniques. In PWM, the width of pulses in a pulse train are modified in direct proportion to a small control voltage. By using a sinusoid of a desired frequency as the control voltage, it is possible to produce a waveform whose average voltage varies sinusoidally in a manner suitable for driving the switches S_{A} 222, S_{B} 224, S_{C} 226, S_{D} 228, S_{E} 230, and S_{F} 232.

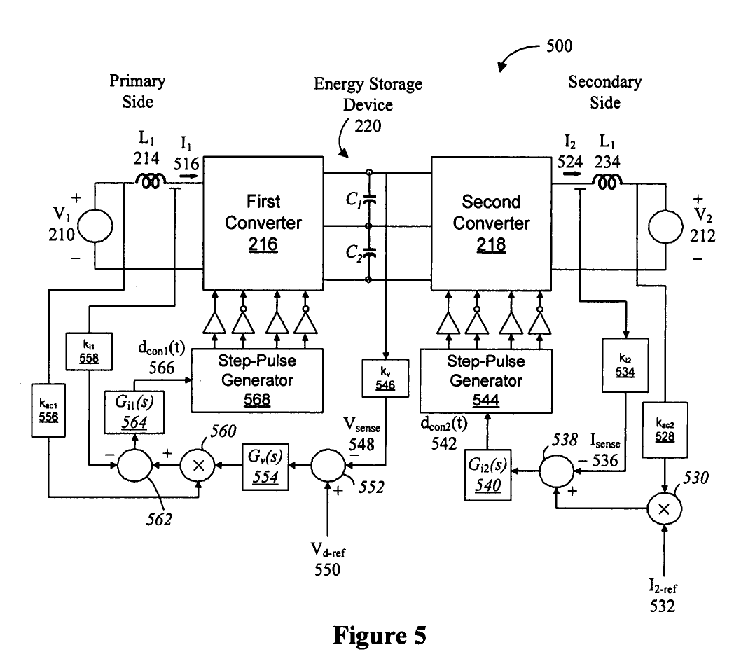

Signals used for driving the switches S_{A} 222, S_{B} 224, S_{C} 226, S_{D} 228, S_{E} 230, and S_{F} 232 may be provided by a control system. This is illustrated in FIG. 5, which is a circuit diagram showing an embodiment of a feedback control system 500. The feedback control system 500 may provide feedback to the first converter 216 and/or the second converter 218. The first converter 216 may be on the primary side or the secondary side, and the second converter 218 may be on the secondary side or the primary side. As an illustrative example, the feedback control system 500 has the first converter 216 on the primary side and the second converter 218 on the secondary side. Note that in a typical application a load is coupled to the output V₂ 212.

In operation, the feedback control system 500 uses the DC bus voltage after the energy storage device 220. The DC bus voltage is scaled kᵥ 546 to generate V_{Sense} 548. A comparator 552 is used to compare V_{Sense} 548 and a reference voltage V_{d-ref} 550. A resulting voltage error signal is coupled to a voltage loop controller Gᵥ(s) 554, which is typically a proportional-integral (PI) controller that applies gain to the voltage error signal. In other embodiments, the voltage loop controller Gᵥ(s) 554 may be a proportional (P) or a proportional-integral-differentiator (PID) controller.

An amplified output from the voltage loop controller Gᵥ(s) 554 is multiplied in multiplier 560 with a scaled k_{ac1} 556 version of the input V₁ 210 voltage. This multiplied output is used as a current reference, which is compared in comparator 562 with a scaled kᵢ₁ 558 version of input current I₁ 516. A resulting first current error signal is amplified in a current controller Gᵢ₁(s) 564. The current controller Gᵢ₁(s) 564 may be a proportional (P), a proportional-integral (PI) controller or a proportional-integral-differentiator (PID) controller.

An output of the current controller Gᵢ₁(s) 564 is a smooth duty cycle signal, d_{con1}(t) 566. Step-pulse generator 568 may use this signal compute a duty cycle of each switch in the first converter 216 using a reference waveform. This computation may be performed by a processor (e.g., microcomputer, digital signal processor) based on one or more computer programs or gate pattern logic stored in a memory (e.g., DRAM, CD-ROM). The processor and the memory may be integrated with the step-pulse generator 568 or may be separate components.

The step-pulse generator 568 may generate pulse-width modulated (PWM) signals for the switches in the first converter 216. This may be accomplished by comparing the computed duty cycle of each switch in the first converter 216 with a value stored in memory. In some embodiments, a PWM signal may be generated for each set of switches. For example, for the first phase leg of the first converter 216 the set of switches S_{A1} 222-1 and S_{A2} 222-2 (FIG. 2) may be controlled by a first PWM signal, and the set of switches S_{A3} 222-3 and S_{A4} 222-4 (FIG. 2) may be controlled by a second PWM signal. The PWM signals are then fed to gate drivers to turn the switches in the first converter 216 on or off. The number of switches in the first converter 216 depends on how many voltage levels and phases are to be controlled.

If the duty cycle d_{con1}(t) is greater than the voltage level of the reference waveform (e.g., a triangular waveform) at any given time t, then the step-pulse generator 568 will turn on the upper switches (e.g., switches S_{A1} 222-1 and S_{A2} 222-2 in FIG. 2) of the first converter 216, and turn off the lower switches (e.g., switches S_{A3} 222-3 and S_{A4} 222-4 in FIG. 2) of the first converter 216.

The elements and functions in the preceding discussion may be appropriately duplicated to provide feedback for three-phase signals in the input V₁ 210 using techniques well-known in the art.

Similarly, feedback may be provided based on the output V₂ 212. A scaled k_{ac2} 528 version of the output V₂ 212 voltage is multiplied in multiplier 530 with a current reference I_{2-ref} 532. A resulting reference current should be in phase with the output V₂ 212 voltage. It is then compared in comparator 538 with a scaled kᵢ₂ 534 version of output current I₂ 524, Iₛₑₙₛₑ 536. A resulting second current error signal is amplified in a current controller Gᵢ₂(s) 540. The current controller Gᵢ₂(s) 540 may be a proportional (P), a proportional-integral (PI) controller or a proportional-integral-differentiator (PID) controller.

An output of the current controller Gᵢ₂(s) 540 is a smooth duty cycle signal, d_{con2}(t) 542. Step-pulse generator 544 may use this signal compute a duty cycle of each switch in the second converter 218 using a reference waveform. This computation may be performed by a processor (e.g., microcomputer, digital signal processor) based on one or more computer programs or gate pattern logic stored in a memory (e.g., DRAM, CD-ROM). The processor and the memory may be integrated with the step-pulse generator 544 or may be separate components. A common processor and/or memory may be used for the step-pulse generator 568 and the step-pulse generator 544. The step-pulse generator 544 may generate pulse-width modulated (PWM) signals for the switches in the second converter 218 in a manner similar to that described above for the step-pulse generator 568.

The feedback control system 500 may be externally programmable using a command interface. The command interface may be used to provide the reference voltage V_{d-ref} 550, the current reference I_{2-ref} 532, and reference waveforms for the step-pulse generator 568 and/or the step-pulse generator 544. The duty cycle signals d_{con1}(t) 566 and d_{con2}(t) 542 (and therefore the output pulse width) may be varied to achieve different frequencies and voltage levels in any desired manner. For example, the step-pulse generator 568 and/or the step-pulse generator 544 can implement various acceleration and deceleration ramps, current limits and voltage-versus-frequency curves by changing variables (e.g., via the command interface) in control programs or gate pattern logic in a processor.

In some embodiments, the feedback control system 500 includes a detection circuit configured to detect when the input power source has a missing phase or is running under a single-phase condition and to generate control signals to be used by the command interface to shut off the switches in one or more phase-legs of the universal auto-transformer.

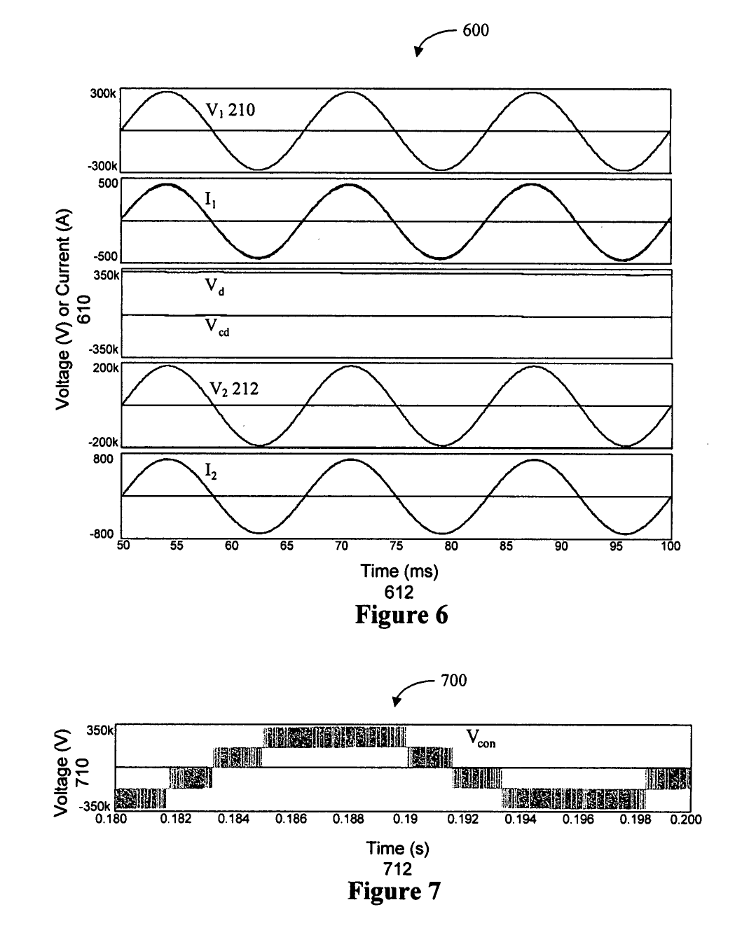

Attention is now directed towards exemplary waveforms in embodiments of an intelligent high-voltage transformer. FIG. 6 is a diagram illustrating input and output signals in an embodiment of an intelligent high-voltage transformer, such as the intelligent high-voltage transformer 200. Simulated voltages (V) and currents (A), including the voltage at the input V₁ 210, the current I₁ at the input, the voltage at the output V₂ 212, the current I₂ at the output, and DC voltages V_{d} and V_{cd}, are shown as function of time 612. Note that current ripple is smoothed out by the inductors L₁ 214 and L₂ 234, and the voltage at the input V₁ 210 and the voltage at the output V₂ 212 are all clean sinusoids.

The voltage between the inductor L₂ 234 and the second converter 218 the waveform is pulse-width-modulated square wave. This is illustrated in FIG. 7 for a simulation of an embodiment of an intelligent high-voltage transformer. In this exemplary embodiment, power is transferred from the primary side to the secondary side, with a total of 200 MW of power for three phases, or 67 MW for each phase. As illustrated in the feedback controller 500 (FIG. 5), other power flow levels may be selected be by adjusting the second reference current I_{2-ref} 532 (FIG. 5).

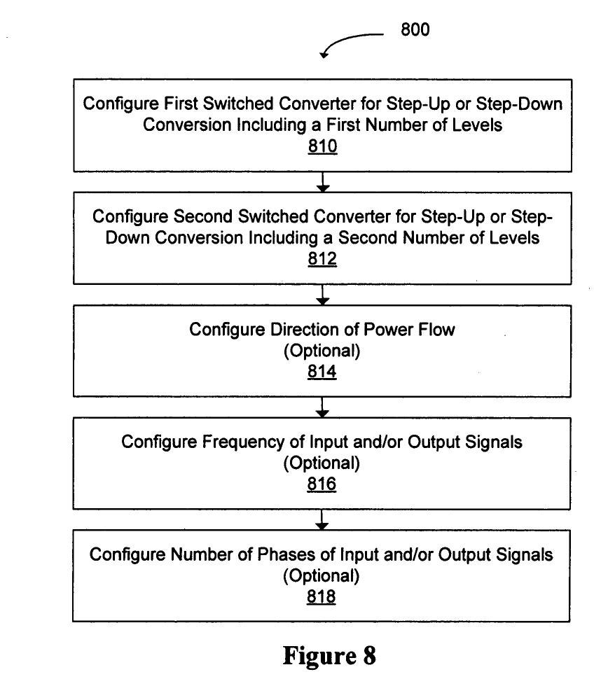

As noted in the previous discussion, in some embodiments the universal auto-transformer may be dynamically configured. This is illustrated in FIG. 8, which is a flow diagram of an embodiment of a process of operation 800 of a universal transformer. A first switched converter circuit is configured for step-up or step-down conversion including a first number of conversion levels 810. A second switched converter circuit is configured for step-up or step-down conversion including a second number of conversion levels 812. A direction of power flow is optionally configured 814. Frequencies of input and/or output signals are optionally configured 816. A number of phases of the input and/or output signals is optionally configured 818. The process of operation 800 may include fewer operations or additional operations. An order or position of two or more operations may be changed. Two or more operations may be combined into a single operation.

Devices and circuits described herein can be implemented using computer aided design tools available in the art, and embodied by computer readable files containing software descriptions of such circuits, at behavioral, register transfer, logic component, transistor, and layout geometry level descriptions stored on storage media or communicated by carrier waves. Data formats in which such descriptions can be implemented include, but are not limited to, formats supporting behavioral languages like C; formats supporting register transfer level RTL languages like Verilog and VHDL; and formats supporting geometry description languages like GDSII, GDSIII, GDSIV, CIF, MEBES; and other suitable formats and languages. Data transfers of such files on machine readable media including carrier waves can be done electronically over the diverse media on the Internet or through email, for example. Physical files can be implemented on machine readable media such as 4 mm magnetic tape, 8 mm magnetic tape, 3½ inch floppy media, CDs, DVDs, and so on.

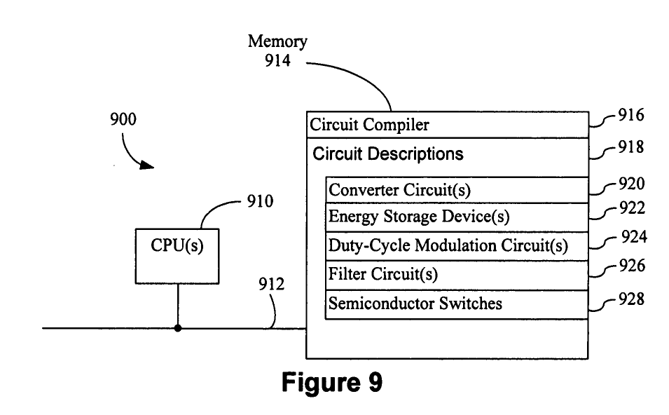

FIG. 9 is a block diagram an embodiment of a system 900 for storing computer readable files containing software descriptions of the circuits. The system 900 may include at least one data processor or central processing unit (CPU) 910, a memory 914 and one or more signal lines 912 for coupling these components to one another. The one or more signal lines 912 may constitute one or more communications busses.

The memory 914 may include high-speed random access memory and/or non-volatile memory, such as one or more magnetic disk storage devices. The memory 914 may store a circuit compiler 916 and circuit descriptions 918. The circuit descriptions 918 may include circuit descriptions for one or more converter circuits 920, one or more energy storage devices 922, one or more duty-cycle modulation circuits 924, one or more filter circuits 926, and semiconductor switches 928.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical application, to thereby enable others skilled in the art to best utilize the invention and various embodiments with various modifications as are suited to the particular use contemplated.

What is claimed is:

1. A power conversion device, comprising:
a switched AC-to-DC converter circuit coupled to a device input; and
a switched DC-to-AC converter circuit coupled to the switched AC-to-DC converter circuit and a device output,
wherein the switched AC-to-DC converter circuit and the switched DC-to-AC converter circuit are configurable for multi-level step-up or step-down conversion.

2. The device of claim 1, wherein the switched AC-to-DC converter circuit is configured to output a DC voltage that is larger than a peak voltage of signals at the device input.

3. The device of claim 1, further comprising a filter coupled to the device input, wherein the filter is configured to provide substantially sinusoidal input signals.

4. The device of claim 1, wherein switched DC-to-AC converter circuit is configured to utilize duty-cycle modulation.

5. The device of claim 1, further comprising a filter coupled to the device output, wherein the filter is configured to provide substantially sinusoidal output signals.

6. The device of claim 5, wherein the switched DC-to-AC converter circuit is configured such that signals between the switched DC-to-AC converter circuit and the filter are pulse-width modulated.

7. The device of claim 1, further comprising an energy storage device coupled between the switched AC-to-DC converter circuit and the switched DC-to-AC converter circuit to mitigate voltage disturbances.

8. The device of claim 7, wherein the energy storage device includes a number of storage devices equal to a number of conversion levels for signals at the device input and the device output.

9. The device of claim 1, wherein the switched AC-to-DC converter circuit and the switched DC-to-AC converter circuit have 11 conversion levels.

10. The device of claim 1, wherein the switched AC-to-DC converter circuit may be configured to adjust a first number of conversion levels of signals at the device input and the switched DC-to-AC converter circuit may be configured to adjust a second number of conversion levels of signals at the device output.

11. The device of claim 1, wherein the switched AC-to-DC converter circuit includes a first plurality of configurable semiconductor switches and the switched DC-to-AC converter circuit includes a second plurality of configurable semiconductor switches.

12. The device of claim 11, wherein the first plurality of configurable semiconductor switches and the second plurality of configurable semiconductor switches include silicon insulated-gate bipolar transistors (IGBT).

13. The device of claim 11, wherein a first number of configurable semiconductor switches in the first plurality of configurable semiconductor switches is selected based on a voltage level of signals at the device input and a voltage limit of the first plurality configurable semiconductor switches, and a second number of configurable semiconductor switches in the second plurality of configurable semiconductor switches is selected based on a voltage level of signals at the device output and a voltage limit of the second plurality configurable semiconductor switches.

14. The device of claim 11, wherein a first number of configurable semiconductor switches in the first plurality of configurable semiconductor switches is selected from a group consisting of 2(N₁−1), 4(N₁−1), and 6(N₁−1), where N₁ is a number of conversion levels of the signals at the device input, and wherein a second number of configurable semiconductor switches in the second plurality of configurable semiconductor switches is selected from a group consisting of 2(N_{O}−1), 4(N_{O}−1), and 6(N_{O}−1), where N_{O} is a number of conversion levels of the signals at the device output.

15. The device of claim 1, wherein the switched AC-to-DC converter circuit is configured to receive signals having a voltage level of substantially 345 kV and the switched DC-to-AC converter circuit is configured to receive signals having a voltage level of substantially 220 kV.

16. The device of claim 1, wherein the device is configurable for bidirectional power flow.

17. The device of claim 1, wherein a frequency of signals at the device output is configurable.

18. The device of claim 1, wherein the switched AC-to-DC converter circuit is configurable to receive signals at the device input having 3-phases separated by substantially 120°.

19. The device of claim 1, wherein the switched DC-to-AC converter circuit is configurable to output signals at the device output having 3-phases separated by substantially 120°.

20. The device of claim 1, wherein the switched AC-to-DC converter circuit is configured to receive signals at the device input having 3-phases separated by substantially 120°.

21. The device of claim 1, wherein the switched DC-to-AC converter circuit is configured to output signals at the device output having 3-phases separated by substantially 120°.
